(19) United States
(12) Patent Application Publication
(10) Pub. No.: US 2012/0242841 A1
(43) Pub. Date: Sep. 27, 2012

(54) SYSTEM AND METHOD FOR TRANSMITTING REAL-TIME IMAGES

(75) Inventors: José Luis Cantero ESCOLÀ, Molins De Rei (Espana) (ES); Alex Bisbe TOSAT, Sant Cugat Del Valles (Espana) (ES)

(73) Assignee: Whisbi Technologies S.L.

(21) Appl. No.: 13/071,590

(22) Filed: Mar. 25, 2011

(51) Int. Cl. H04N 7/173; H04N 5/225

(52) U.S. Cl. 348/207.1; 725/109; 348/E05.024

(57) ABSTRACT

System comprising an image server computer (4) accessible via telematics networks by some transmitting equipments (1) for transmitting of single images via TCP or HTTP protocol, but conforming consecutive sequences constituting an animation. The image server computer (4) comprises in its memory some memory spaces (5) where stores the last image received from each sequence transmitted by the transmitting equipment (1) according to a unique identifier “guid” code, updating in real-time said animation. The system comprises some receiving equipments (6) equipped with web browsers (7), in which it can be displayed the sequence of images received via HTTP protocol after a request to the image server computer (4) indicating the identifier “guid” via TCP or HTTP requests using standard TCP/IP communication sockets.

### OBJECT OF THE INVENTION

The present invention relates to a system and method for transmitting images in real time, with which it can send and receive pictures via telematics networks, e.g. Internet.

### FIELD OF APPLICATION OF THE INVENTION

This invention is applicable in the field of transmission of video images and multimedia content distributed in telematics networks and connection of computers or devices with computing capability.

### BACKGROUND OF THE INVENTION

The transmission of real-time images through telematics networks is a service increasingly demanded by users.

Currently, in order to transmit and receive real-time images is required that the computer or receiving device have installed specific software (players such as Adobe Flash Player, for example), which vary with its corresponding updates, and in many cases are not available for all devices capable of playing images on a screen.

This software is installed as stand-alone applications, or more commonly, as web browser plug-ins, enabling the display of content from devices that use browsers. The main problem with this type of software is that is not available for all platforms and devices capable of playing images, such as less advanced browsers or with limited capabilities for example mobile phones. These devices can not use Internet to play real-time images or are become obsolete in a short time compared to newer versions of the software that can not be updated.

Another problem of the current systems is that the treatment performed in real-time images, converting them to a movie, requires high bandwidth and a massive use of processor and memory resources. This environment makes impossible to a large extent the evolution of the real-time online video through massive networks like Internet.

The Applicant of the present invention does not know of the existence of background that resolves satisfactorily the exposed issues.

### DESCRIPTION OF THE INVENTION

The system and method for transmitting real time images, object of this invention, presents some technical particularities intended to enable that any user can transmit video in real-time and this can be consumed massively by other users from any device with a web browser. The system and method make possible said consumption in devices or receiving equipments connected to telematics networks which are equipped with web browsers without great requirements, enabling the reception of images or video sequences in real time without the need of additional reproduction software or specific video plug-ins for the web browser.

Thus, the system is of the type comprising some transmitting equipments, equipped with some image capture devices, and connected to a telematics network; an image server equipment, also connected to the communication telematics network, and some receiving equipments equipped with software corresponding to web browsers.

The designed system meets the following objectives:

a) the image-transmitting equipment may perform said transmission via standard communication protocols such as TCP or HTTP.
b) The bandwidth consumed for the communication is minimal.
c) The image display is performed in web browsers that meet at least with HTTP 1.1 and JavaScript.

According to the invention:

The transmitting equipments comprise a individual image transmission software via TCP or HTTP protocol as individual and independent image transmission sequences as an identifier “guid” code in the sequence of transmissions,

the server equipment includes some memory spaces corresponding to the different identifier “guid” codes in which are stored individually an image transmitted by the transmitting equipment, and which is updated with the latest image received from the transmitting equipment for its forwarding to the receiving equipments on demand, as individual and independent image transmissions compatible with the HTTP protocol for viewing in a web browser, generating a streaming of consecutive images for each identifier “guid” code of the transmitting equipments.

This system has advantages, since the play is performed entirely by HTTP and JavaScript that recognize the standard web browsers of various devices, from modern computers to simple devices such as mobile phones with multimedia capability. These receiving equipments do not need the installation of additional software or web browser plug-ins, thus avoiding issues of compatibility or updating thereof.

In one embodiment, the image server equipment comprises means for editing and processing images stored temporarily on the memory spaces.

Identifier “guid” codes are stored in a list on the image server equipment for their creation, consultation and deletion. Thus, when the different memory spaces are established their identifier “guid” codes are kept at hand quickly and accessible. Once stopped the transmission of images by a transmitting equipment said identifier “guid” code is removed from the list and the corresponding memory space is freed for reuse.

According to the invention, the method for transmitting real-time images comprises:

the communication via TCP or HTTP protocol of at least one transmitting equipment (1) with an image server equipment (4), in which is negotiating a connection for transmitting an image with an identifier “guid” code,

the creation of a memory space (5) on the image server equipment (4), corresponding to the identifier “guid” code of the sequence of image transmissions for the storage of the received images,

the storage of the image received via the image server equipment (4) in the memory space (5) corresponding to the associated identifier “guid” code,

the consecutive transmission of subsequent independent and individual images with their corresponding identifier “guid” code to the image server equipment (4) for incorporation into the memory space (5) corresponding to the associated identifier “guid” code,

the connection of remote receiving equipment (6) to the image server computer (4) via HTTP protocol requesting the transmission via said HTTP protocol of the image stored on a memory space (5) corresponding to a determined identifier “guid” code, and the sequential repetition of said request for the reception of subsequent images stored on said memory space (5), conforming a real-time video animation.

This procedure does not require the use of specific software in the receiving equipment. The image transmission from the transmitting equipments to the image server equipment and from said image server equipment to the receiving equipments is performed via HTTP and TCP/IP protocols which are completely safe and compatible with the security systems used by various operators and administrators of telematics networks avoiding security conflicts.

Thus, an image server equipment is continuously listening through a specific port (such as the Tcp port 80hex), standard communication port via Internet, and does not cause problems with the companies' security systems.

When this image server equipment receives a request from said port, processes it and replies. It can be received 3 types of requests, identified by the literal sense thereof. Each request is treated in a different thread, allowing multiple simultaneous connections.

a) Request from the transmitter: with literal “Desktop”. This request is treated via TCP/IP protocol, by opening a specific socket and establishing a persistent point-to-point communication under this protocol.
b) Request from the transmitting equipment: with literal “HDesktop”. This request is treated via HTTP protocol, by opening the specified socket and establishing a persistent point-to-point communication under this protocol, using the standard HTTP 1.1. These requests are always of the type “post” to deliver content to the image server equipment.
c) Request from the receiving equipment: with literal “Client”. This request is always treated under HTTP protocol, with the standard HTTP 1.1, and tries to be persistent while it is possible. These requests are always of the type “get” to get content from the image server equipment.

When the image server equipment receives a request such as “Desktop” from the transmitting equipment,

Establishes and reinforces the communication via socket,

Searches on the query string an identifier “guid” code which will identify the delivered images,

Working always on the memory, searches if said variable already exists, if not, assigns a specific memory space (Pointer).

Indicate to the other point that is ready to receive content.

Once performed this negotiation phase, the point-to-point connection will be maintained while is active.

After the negotiation phase is finished the transmitting equipment sends a statement “setcontent”, indicating:

a—The type of image that is going to receive
b—The size of the same
c—The image in binary

The image server equipment, when receives this statement, it is awaiting for receiving the entire image (total bits defined in size).

When the reception of the image ends, the image server equipment performs the following:

In the memory space pointer assigned to this communication identified by the identifier “guid” code above, stores this image.

It sends a statement to the transmitting equipment “nextcontent” as it can send more content, and is awaiting for receiving the next “setcontent”.

If at some time the communication between the transmitting equipment and the image server equipment was cut off, this can be re-established, by passing again through the negotiation phase, by accessing the same memory space as long as was delivered the same identifier “guid” code than in the initial negotiation.

When the image server equipment receives a request of the type “Hdesktop” from the transmitting equipment will be performed the following steps.

Establishes and reinforces the communication via socket,

Searches on the query string an identifier “guid” code which will identify the delivered images,

Working always on the memory, searches if said identifier “guid” code already exists, if not, assigns it a specific memory space (Pointer).

This request has come via the “POST” method of the HTTP 1.1 protocol. Said protocol has a header that indicates the total message size and type of content. The message received consists of the image in binary. The image server equipment, when receives this statement, is awaiting for receiving the entire request (total bits defined in the message header).

When the reception of the same ends, performs the following:

In the assigned memory pointer to this identified “guid” code above, stores this image, after re-encoding it to binary.

Following the HTTP protocol is answered to the request with “ok” or an “error”, being awaiting for receiving the next content.

While it is possible this socket will be remained active, avoiding thus in successive deliveries the starting point.

When the image server equipment receives a request of the type “Client” from the receiving equipment the following steps are carried out:

Establishes and reinforces the communication.

Searches on the query string an identifier “guid” code which will identify the images to be received.

This request has come via the “get” method of the HTTP 1.1 protocol, so expect to receive a content.

Always working on memory, searches if said identifier “guid” code already exists. If not, via HTTP 1.1 protocol is delivered a blank image.

If the identifier “guid” code exists, using a corresponding pointer of the memory space is delivered the contained image, under HTTP 1.1 protocol. This is made by creating the specific header for this protocol where is defined the image format, size . . . and content. This form of delivering is compatible with any current browser.

Therefore, always it will be delivered, sequentially the last image received from the transmitting equipment.

From this point, with the help of JavaScript statements to generate a recurring sequence which simulates the animation of the same under a continuous video.

Thus, we have a specific memory space on the server, where it is stored, only the last image sent by the transmitting equipment.

The image reception in the receiving equipment is made at any time and does not require the creation and maintenance of its own data or image buffer of data or images, which gives fluidity to the received sequence of images. This sequence of images is produced by the application itself from the receiver equipment to the image server equipment and is robust to connection failures, with no exceptions caused due to the saturation of the bandwidth of communication, such as in other players of real-time animated images or video stored on prerecorded files.

Communications between the transmitting equipments, receiving equipments and image server equipment are performed using standard TCP/IP sockets. These sockets allow mainly the transmission of images by establishing the transmission port in a standardized negotiation, the type of content, which in this case is an image in JPG, GIF, BMP format, or similar, the length of such content and the image in itself as content.

The image server equipment can perform an editing of the images received from the transmitting equipment (1) before being placed on the corresponding memory spaces. In this way it can be added subtitles, logos, date and time indications, or any other information, in addition to improve the quality of the image if possible.

Similarly, the method also comprises the storage of successive images received from the transmitting equipments in sequential files from the image server equipment. This storage can be internal or sent to an external storage system, making it possible to review the spread images by the transmitting equipments.

If the receiving equipment makes a request to the image server equipment of a “guid” identification that has not assigned a space in active memory, the server equipment returns a blank image or an image indicating said situation.

It is envisaged that a transmitting equipment has assigned different identifiers corresponding to different capture devices that are transmitted independently to the image server equipment. Thus the same transmitting equipment may transmit images from different captures.

This system allows that a receiver equipment equipped with a basic browser, for example adapted for the representation of web pages according to HTTP 1.1 and JavaScript protocols, can play video and image sequences in real time and with minimal bandwidth requirements. The run of JavaScript enables that the web page on which the web browser of the different equipments can automatically and persistently maintain the sequence of requests and transmissions of images to be manipulated and visualized.

With this system and method is obtained a standardized way for sending sequentially real-time images. The transmission of images is performed through a central server equipment that collects and delivers the information from multiple points. This server equipment always works on memory, maintaining only the last image received.

Very few resources are therefore required in order to maintain a live video session, only the size in memory of the last image received.

On the other hand, this system does not respect the real emission timeline, since everything is done on demand, being able to produce an irregular loss of intermediate images. However, this loss is done transparently to the system, without entailing the generation of execution errors and exceptions, making that the operating systems of the equipments run more stable.

### DESCRIPTION OF THE FIGURES

In order to complement the description being made and in order to facilitate understanding of the features of the invention is attached to this specification a set of drawings in which, with illustrative and non-limitative character, the following is set forth:

FIG. 1 shows a simplified scheme of the system.

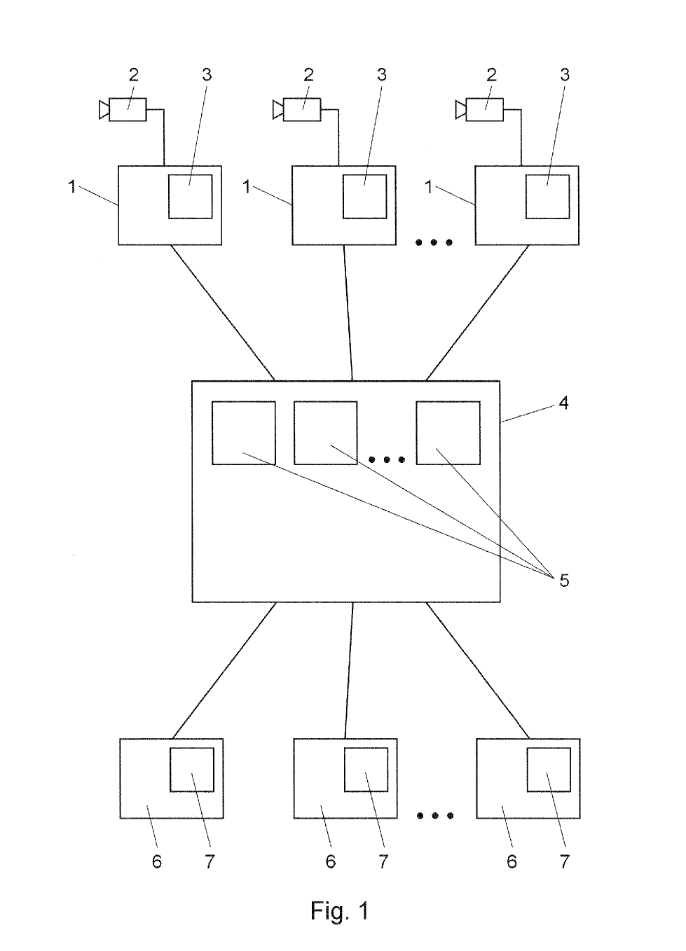

### PREFERRED EMBODIMENT OF THE INVENTION

As can be seen in the referenced figures, the system comprises some transmitting equipments (1) connected to a telematics network by various means for its communication. Each of these transmitting equipments (1) is fitted with image capture devices (2), in this case “webcams”, and run a software (3) specific for image capture and transmission through the telematics network via a TCP or HTTP protocol utilizing sockets in standard TCP/IP ports, such as the port 80hex. In this case the communications in telematics networks have been represented as connecting lines corresponding to the data flows.

These transmitting equipments (1) are connected to a central image server equipment (4). This image server equipment (4) comprises a memory in which are conformed some memory spaces (5) associated with the identifier “guid” code of each transmission sequence of images and enough memory for the storage of an image, being the image stored in said memory space (5) substituted by the last image received from the transmitting equipment (1) identified by the identifier “guid” code, for its real-time updating.

The system comprises some receiving equipments (6) for displaying images in real time. These receiving equipments (6) are connected via the cited telematics networks to the image server equipment (4), being said receiving equipments (6) computer devices and electronic apparatus equipped with web browsers (7) with multimedia capability to display on a screen the images received from the image server equipment (4). The web browser (7) of each receiving equipment (6) performs a request using the HTTP 1.1 protocol and JavaScript to request the image stored on the memory space (5) identified by a specific identifier “guid” code corresponding to one of the image capture device (2) from a transmitting equipment (1). The image server equipment (4) starts a socket and transmits the image in that moment is stored in said memory space (5) to the solicitor receiving equipment (6). Once the last image received by the receiving equipment (6) has been represented by the web browser (7), said web browser (7) performs, using some JavaScript instructions, a new request to the image server equipment (4) with the same identifier “guid” code.

An example of a request by the transmitting equipment (1) to the image server computer (4) transmitting an image is shown below, being only an example:

<!DOCTYPE HTML PUBLIC ‘-//W3C//DTD HTML 4.0
Transitional//EN’>
<html> <head> <meta http-equiv=‘Expires’ content=‘0’> <title>Whisbi
Streaming Server JavaScript</title>
<script language=‘JavaScript’ type=‘text/JavaScript’>
image1 = new Image( 0, 0);
image1.src = ‘http://[streaming server address]/client?guid=[guid
identifier] HTTP/1.1
Accept: image/jpeg, appl’;
function repaint( ) {
if (image1.complete == true) {
if (image1.width == 0) {
setTimeout(‘reload( );’, 10);}
else{
document.tmpimage1.src = image1.src;};
}
else {
setTimeout(‘repaint( );’, 50);};
};
function reload( ) {
var random_num = Math.round(Math.random( ) * (10000000000));
var s = new String(random_num);
image1.src = ‘http://[streaming server address]/client?guid=[guid
identifier] HTTP/1.1
Accept: image/jpeg, appl’+ s;
setTimeout(‘repaint( );’, 100);
};
</script> </head> <body>
<img id=‘tmpimage1’ alt=‘’
src = ‘http://[streaming server address]/client?guid=[guid identifier]
HTTP/1.1
Accept: image/jpeg, appl’
style = ‘height: 100%; width: 100%; position: absolute; top:
0px; left: 0px; visibility: visible;’
name = ‘tmpimage1’ onload=‘reload( );’ onerror=‘reload( );’/>
</body></html>

This example would make sequentially requests for images, always getting the last image received from the transmitting equipment (1).

Once sufficiently described the nature of the invention as well as a preferable embodiment, it is stated for the opportune purposes that the materials, shape, size and arrangement of elements described may be modified, providing that this does not suppose the alteration of the essential features of the invention which are claimed below.

1. System for transmitting real-time images of the type of comprising some transmitting equipments (1), equipped with some image capture devices (2), and connected to a telematics network, an image server equipment (4) also connected to the communication telematics network, and some receiving equipments (6) equipped with software corresponding to web browsers (7), characterized in that:
the transmitting equipments (1) comprise a individual image transmission software (3) via TCP or HTTP protocol as individual and independent image transmission sequences as an identifier “guid” code in the sequence of transmissions,
the image server equipment (4) comprises some memory spaces (5) corresponding to the different identifier “guid” codes in which are stored individually an image transmitted by the transmitting equipment (1), and which is updated with the latest image received from the transmitting equipment (1) for its forwarding to the receiving equipments (6) on demand, as individual and independent image transmissions compatible with the HTTP protocol for viewing in a web browser (7), generating a streaming of consecutive images for each identifier “guid” code of the transmitting equipments (1).

2. System according to claim 1 characterized in that the image server equipment (4) comprises means for editing and processing images temporarily stored on the memory spaces (5).

3. System according to claim 1 characterized in that the identifier “guid” codes are stored in a list on the image server equipment for their creation, consultation and deletion.

4. Method for transmitting of real time images characterized in that comprises:
the communication via TCP or HTTP protocol of at least one transmitting equipment (1) with an image server equipment (4), in which is negotiating a connection for transmitting an image with an identifier “guid” code,
the creation of a memory space (5) on the image server equipment (4), corresponding to the identifier “guid” code of the sequence of image transmissions for the storage of the received images,
the storage of the image received via the image server equipment (4) in the memory space (5) corresponding to the associated identifier “guid” code,
the consecutive transmission of subsequent independent and individual images with their corresponding identifier “guid” code to the image server equipment (4) for incorporation into the memory space (5) corresponding to the associated identifier “guid” code,
the connection of remote receiving equipment (6) to the image server computer (4) via HTTP protocol requesting the transmission via said HTTP protocol of the image stored on a memory space (5) corresponding to a determined identifier “guid” code, and the sequential repetition of said request for the reception of subsequent images stored on said memory space (5), conforming a real-time video animation.

5. Method according to claim 4, characterized in that the communications between the transmitting equipments (1), receiving equipments (6) and image server equipment (4) are performed using standard TCP/IP sockets.

6. Method according to claim 5, characterized in that the image server equipment (4) performs an editing of the images received from the transmitting equipment (1) before being placed on the corresponding memory spaces (5).

7. Method according to claim 4, characterized in that comprises the storage of the successive images received from the transmitting equipments (1) in sequential files from the server equipment.

8. Method according to claim 4, characterized in that if the receiving equipment (6) performs a request to the image server equipment (4) of a “guid” identification which has not assigned an active memory space (5), the image server equipment (4) returns a blank image or an image indicating said situation.

9. Method according to claim 4, characterized in that a transmitting equipment (1) has assigned different identifiers corresponding to different image capture devices (2) which are transmitted independently to the image server equipment (4).
